(19) United States
(12) Patent Application Publication
(10) Pub. No.: US 2020/0259940 A1
(43) Pub. Date: Aug. 13, 2020

(54) OPTIC CELL PHONE SCREEN COVER

(71) Applicant: Steven Arnold, Hudson Falls, NY (US)

(72) Inventor: Steven Arnold, Hudson Falls, NY (US)

(21) Appl. No.: 16/801,310

(22) Filed: Feb. 26, 2020

Related U.S. Application Data
(60) Provisional application No. 62/803,402, filed on Feb. 8, 2019.

(51) Int. Cl. H04M 1/02; G02B 3/00

(52) U.S. Cl. CPC H04M 1/0266; G02B 2003/0093; G02B 3/00

(57) ABSTRACT

A cover for a display screen is disclosed herein. The cover includes a lens layer and a protective layer. The cover is for attachment to a display screen of an electronic device, particularly a cell phone. The lens layer includes a corrective means such as a prescription lens configured to assist users in viewing their phone screen without glasses/lenses.

### CROSS-REFERENCE TO RELATED APPLICATION(S)

The present application is related to and claims priority to U.S. Provisional Patent Application No. 62/803,402 filed Feb. 8, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of electronics accessories of existing art and more specifically relates to display screen covers.

### RELATED ART

A corrective lens is a lens typically worn in front of the eye to improve vision. The most common use is to treat refractive errors: myopia, hypermetropia, astigmatism, and presbyopia. Glasses are worn on the face a short distance in front of the eye and contact lenses are worn directly on the surface of the eye. Individuals that require the use of corrective glasses often have difficulty putting them on quickly when needed. If an individual's phone rings, it can be hard to see the display screen without one's glasses. It is not always possible to quickly put on the glasses to see the phone. Without a way to correct this, the individual may miss important calls or messages. A suitable solution is desired.

U.S. Pat. No. 9,772,498 to Dana Conrad Kowasic relates to a magnified screen cover protector for electronic devices. The described magnified screen cover protector for electronic devices includes a magnified screen cover and protector. The invention comprises a magnified surface layer with a top protective layer and a bottom adhesive layer. The invention magnifies the screen of an electronic device with diopter and/or magnification power ranges so that the user may comfortably use the electronic device without the aid of wearing prescription eyewear, contact lenses, reading glasses or other visual aids. The touch screen sensitivity and functionality of the electronic device is unaffected by the magnified screen cover protector, so usability of the electronic devices touch and sensitivity functions are not compromised.

### SUMMARY OF THE INVENTION

In view of the foregoing disadvantages inherent in the known corrective and magnifying display screen cover art, the present disclosure provides a novel optic cell phone screen cover. The general purpose of the present disclosure, which will be described subsequently in greater detail, is to provide a protective cell phone screen cover including a prescription lens to assist users in viewing their phone screen without glasses/lenses.

A cover is disclosed herein. The cover may be for attachment to a display screen and may be used by users with at least one eye having a refractive error. The cover for the display screen includes a lens layer and a protective layer. The lens layer may include a front lens surface and a rear lens surface configured for attachment to the display screen, the lens layer being made from a first transparent material. The lens layer may be structurally configured to focus light into the at least one eye of the user at an optical power corresponding to a predetermined vision prescription of the user so as to substantially correct the refractive error of the at least one eye of the user when the user is viewing the display screen through the cover. The protective layer may include a front protective surface and a rear protective surface, the rear protective surface being fixedly attached to the front lens surface of the lens layer, and protective layer being made from a second transparent material so as to not impede a clarity of the lens layer.

According to another embodiment, a method of creating a cover for a display screen is also disclosed herein. The method includes providing the cover as above; determining the predetermined vision prescription of the user; generating the optical power based on at least the predetermined vision prescription of the user; creating the lens layer with the optical power; creating the protective layer; and fixedly attaching the rear protective surface of the protective layer to the front lens surface of the lens layer to create the cover, the cover having a size substantially equal to the display screen.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an optic cell phone cover, constructed and operative according to the teachings of the present disclosure.

FIG. 1A is a front view of the cover during an ‘in-use’ condition, according to an embodiment of the disclosure.

FIG. 1B is a front view of the cover during an ‘in-use’ condition, according to an embodiment of the disclosure.

FIG. 2 is a side view of the cover of FIG. 1, according to an embodiment of the present disclosure.

FIG. 3 is a side view of the cover of FIG. 1, according to an embodiment of the present disclosure.

FIG. 4 is a side view of the cover of FIG. 1, according to an embodiment of the present disclosure.

FIG. 5 is a flow diagram illustrating a method of creating a cover for a display screen, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to display screen covers and more particularly to an optic cell phone cover as used to improve display screen covers by providing an convenient and easy device for those with vision impairments to read their phone, and eliminates the need for users to wear their reading glasses each time they want to use their phone.

Generally, disclosed is a cell phone display screen cover designed to not only protect the display screen but also to correct the screen for individuals that typically require corrective lenses. The cell phone display screen cover may include a protective cover and lens protector that is applied to the display screen. The cell phone display screen cover may be transparent to allow light to pass therethrough accurately, and includes a vision prescription, like that of a contact lens or eyeglass lens. The lens can be made to match the user's exact prescription. The cover may come in a variety of shapes and sizes to accommodate all phones. Packs of multiple covers may be sold with varying prescriptions. The exact specifications may vary.

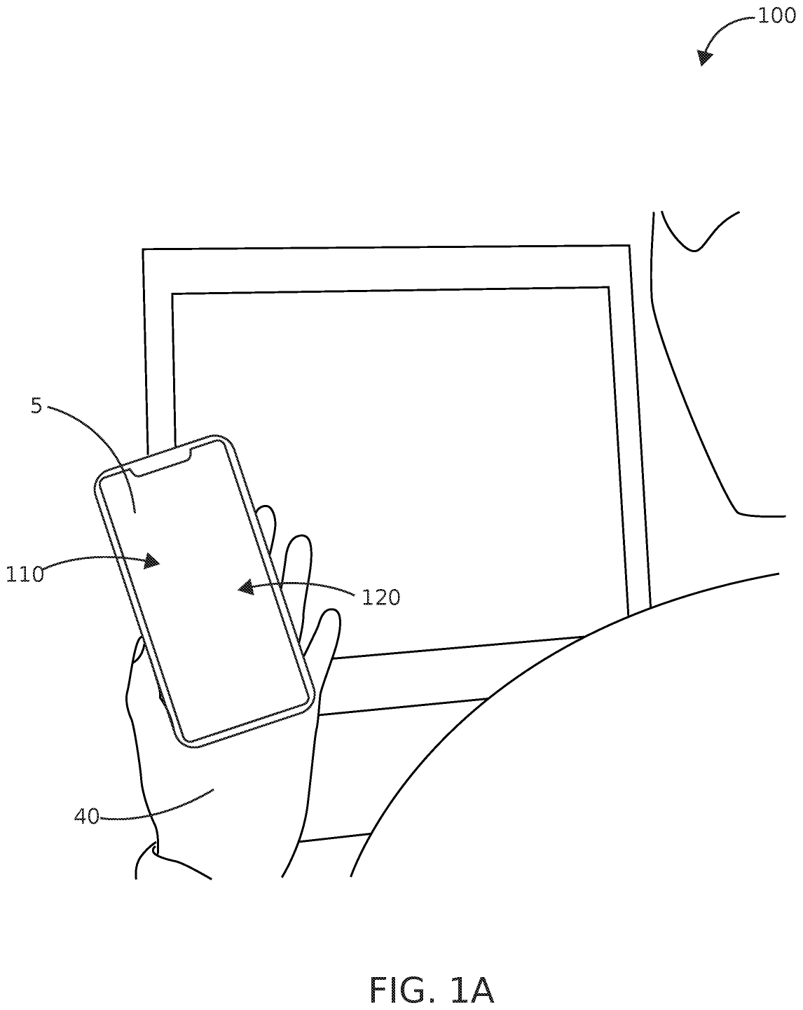

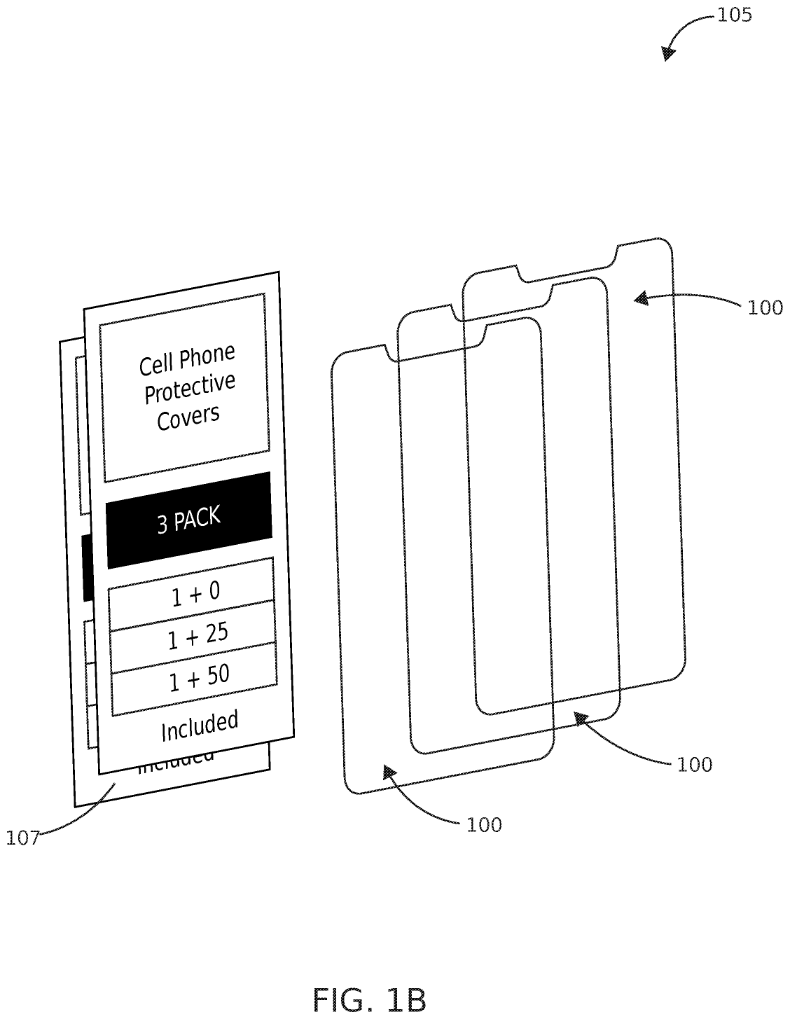

Referring now more specifically to the drawings by numerals of reference, there is shown in FIGS. 1A-4, various views of a cover for a display screen (“cover” 100).

FIGS. 1A-1B show the cover 100 during an ‘in-use’ condition, according to an embodiment of the present disclosure. Here, the cover 100 may be beneficial for use by a user 40 to assist users 40 in viewing their display screen without glasses. As illustrated, the cover 100 may include a lens layer 110 and a protective layer 120. The cover 100 being for use by users 40 with at least one eye having a refractive error.

According to one embodiment, the cover 100 may be arranged as a kit 105. In particular, the cover 100 may further include a set of instructions 107. The instructions 107 may detail functional relationships in relation to the structure of the cover 100 such that the cover 100 can be used, maintained, or the like, in a preferred manner. Further, the kit may include at least two covers 100 having different optical powers.

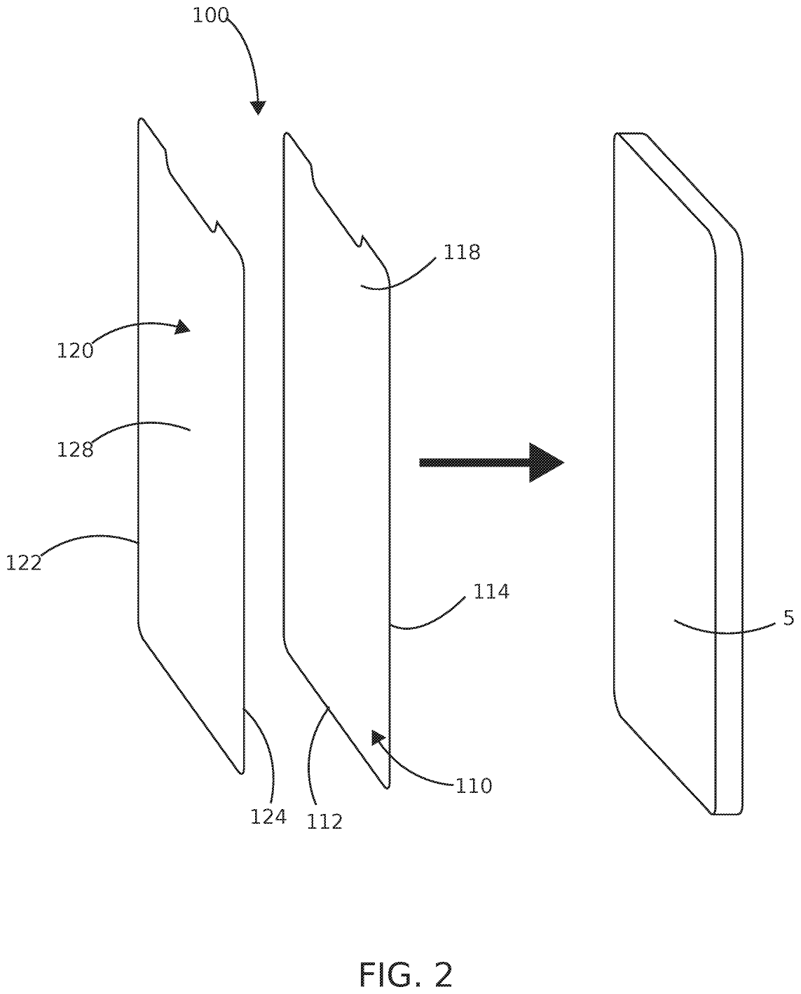

FIG. 2 shows the cover 100 of FIG. 1, according to an embodiment of the present disclosure. The lens layer 110 may include a front lens surface 112 and a rear lens surface 114 configured for attachment to the display screen 5. Preferably, the lens layer 110 is made from a first transparent material. The protective layer 120 may include a front protective surface 122 and a rear protective surface 124, the rear protective surface 124 being fixedly attached to the front lens surface 112 of the lens layer. The protective layer 120 may be fixedly attached via adhesive, heat fusion, etc.

Preferably, the protective layer 120 is made from a second transparent material 128 to not impede the clarity of the lens layer 110. In one embodiment, the first transparent material 118 may be different from the second transparent material 128. In another embodiment, the first transparent material 118 and the second transparent material 128 may be the same. The first transparent material 118 may be glass, plastic, polycarbonate, or the like. Similarly, the second transparent material 128 may be glass, plastic, polycarbonate, or the like. In some embodiments, a third layer may be included in the cover 100 (not shown). The third layer may be an attachment layer fixedly attached to the rear lens surface 114 and configured to attach the lens layer 110 and the protective layer 120 to the display screen 5. The third layer may be made of a third transparent material which may be different or the same as at least one of the first transparent material 118 or the second transparent material 128.

In one embodiment, the first transparent material 118 and the second transparent material 128 may be made of a lightweight material capable of building an electrostatic charge so as to attach the rear lens surface 114 to the display screen 5 via static electricity. In another embodiment, the rear lens surface 114 may include an adhesive thereon to adhesively attach the rear lens surface 114 to the display screen 5. Other attachment means are contemplated. For example, the cover 100 may be wetted with a liquid such as water to attach it to the display screen 5.

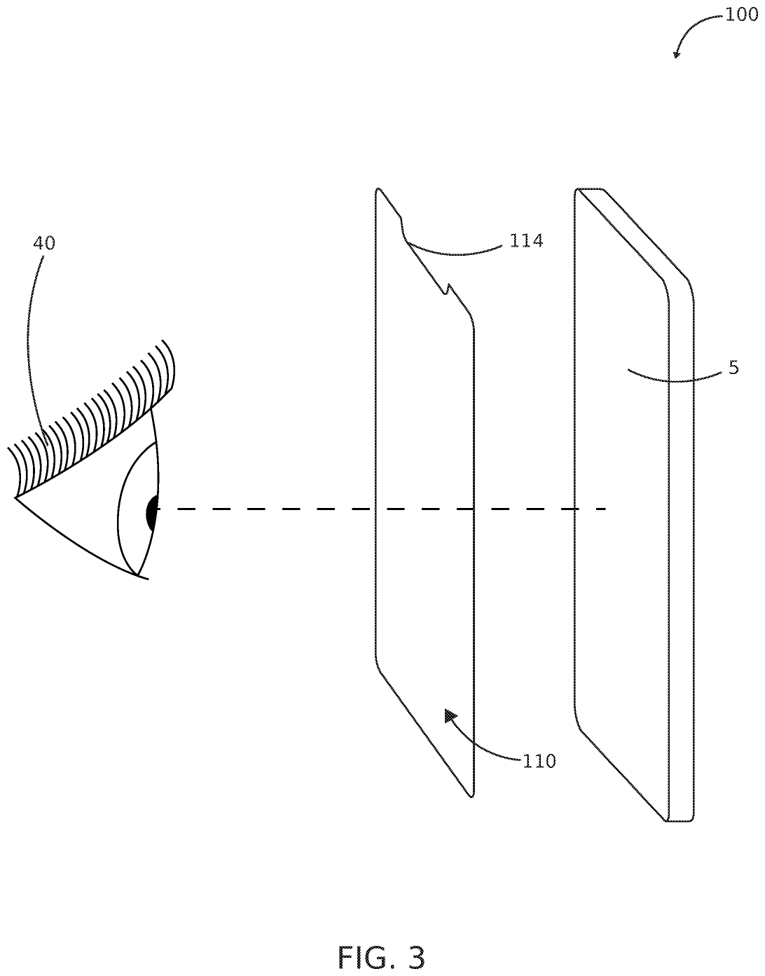

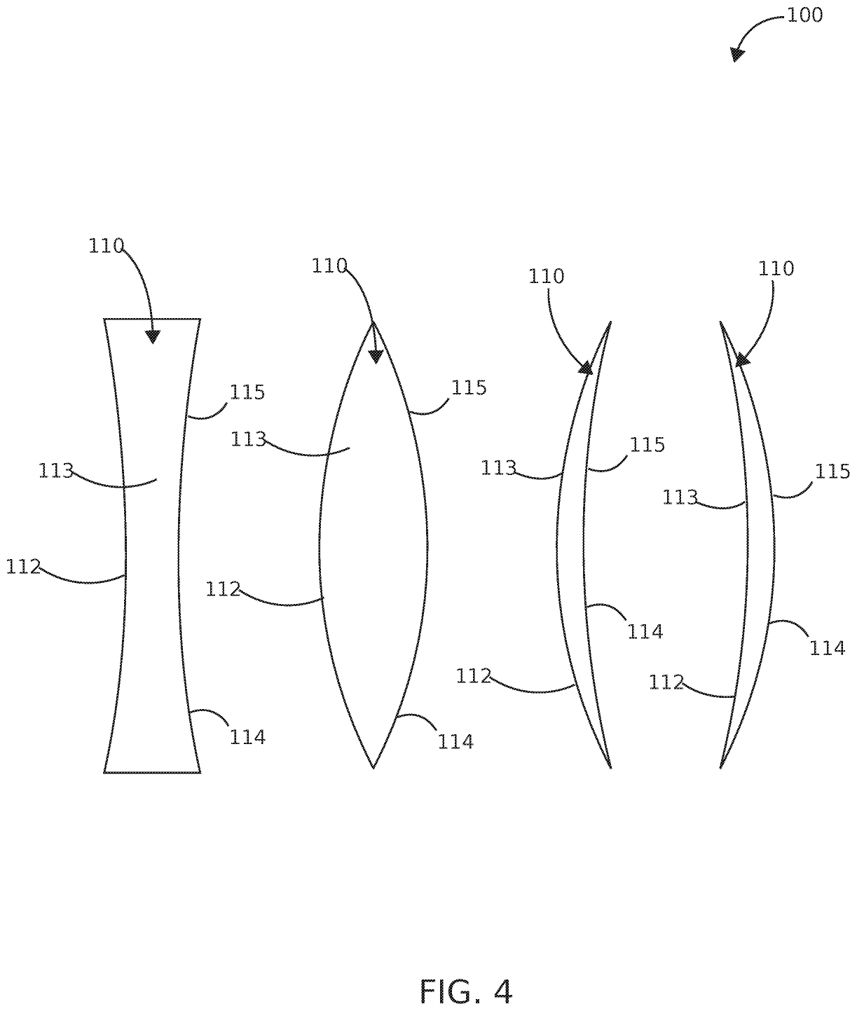

FIG. 3-4 are side views of the cover 100 of FIG. 1, according to an embodiment of the present disclosure. The lens layer 110 may be structurally configured to focus light into the at least one eye of the user at an optical power 116 corresponding to a predetermined vision prescription of the user so as to substantially correct the refractive error of the at least one eye of the user when the user is viewing the display screen 5 through the cover 100. Preferably, the predetermined vision prescription of the user includes a measurement in diopters. Further, the predetermined vision prescription of the user may include one of a far point and near point of the user. In some embodiments, the lens layer 110 may include magnification only.

The optical power 116 of the lens layer 110 may be generated based on the predetermined vision of the user. In one embodiment, the optical power 116 may be generated based on the predetermined vision prescription of the user and a distance range between the at least one eye of the user and the display screen 5 during use. This may aid in accuracy of the lens layer 110, as a focal point of the lens layer 110 may be different than a focal point of a generic eyeglass that the user wears and has been given their predetermined vision prescription for. This is due to a greater vertex distance between the at least one eye of the user and the rear lens surface 114 (attached to the display screen 5) as compared with a vertex distance between the at least one eye of the user and the generic eyeglass that the user wears. As such, the optical power 116 of the lens layer 110 may need to be more or less powerful than the predetermined vision prescription. This variation may depend on a variety of individual factors such as focal range of the user (their far point and near point), vision prescription, type of visual impairment or refractive error (nearsighted, far-sighted, etc.), shape of eye, and the like. This may be predetermined by a separate system, or included as a system in the present disclosure.

A curvature of the lens layer 110 may be determined by the predetermined vision prescription of the user. This may again be determined by a variety of individual factors. In one embodiment, the lens layer 110 may include a convex-concave profile. In this embodiment, the front lens surface 112 may have a first curvature 113 and the rear lens surface 114 may have a second curvature 115. The first curvature 113 and the second curvature 115 may be the same. For example, if the user 40 is farsighted, the first curvature 113 and the second curvature may both be convex. In this embodiment, the first curvature 113 and the second curvature 115 are configured to converge light into the at least one eye of the user. Inversely, if the user 40 is nearsighted, the first curvature 113 and the second curvature 115 may be concave. In this embodiment, the first curvature 113 and the second curvature 115 are configured to diverge light into the at least one eye of the user. In another embodiment, the first curvature 113 and the second curvature 115 may be different. In one embodiment, the first curvature 113 may be convex and the second curvature 115 may be concave.

A difference in curvature between the first curvature 113 and the second curvature 115 may determine the optical power 116 of the lens layer 110. The difference in curvature between the first curvature 113 and the second curvature 115 may be determined by the predetermined vision prescription of the user. For example, the user 40 may be farsighted, and the first curvature 113 may be greater than the second curvature 115, allowing the front lens surface 112 to overpower the rear lens surface 114 and converge light into the at least one eye of the user. Inversely in another example, the user may be nearsighted, and the second curvature 115 may be greater than the first curvature 113, allowing the rear lens surface 114 to overpower the front lens surface 112 and diverge light into the at least one eye of the user.

To accommodate for the curvature of second curvature 115 (the rear lens surface 114), the third layer as discussed above (not shown) may be beneficial for allowing the cover 100 to attach to the display screen 5 properly by conforming to the second curvature 115 to create a flat surface similar to a surface of the display screen 5. In other embodiments, the curvature of the lens layer 110 may be subtle enough that the third layer would not be needed.

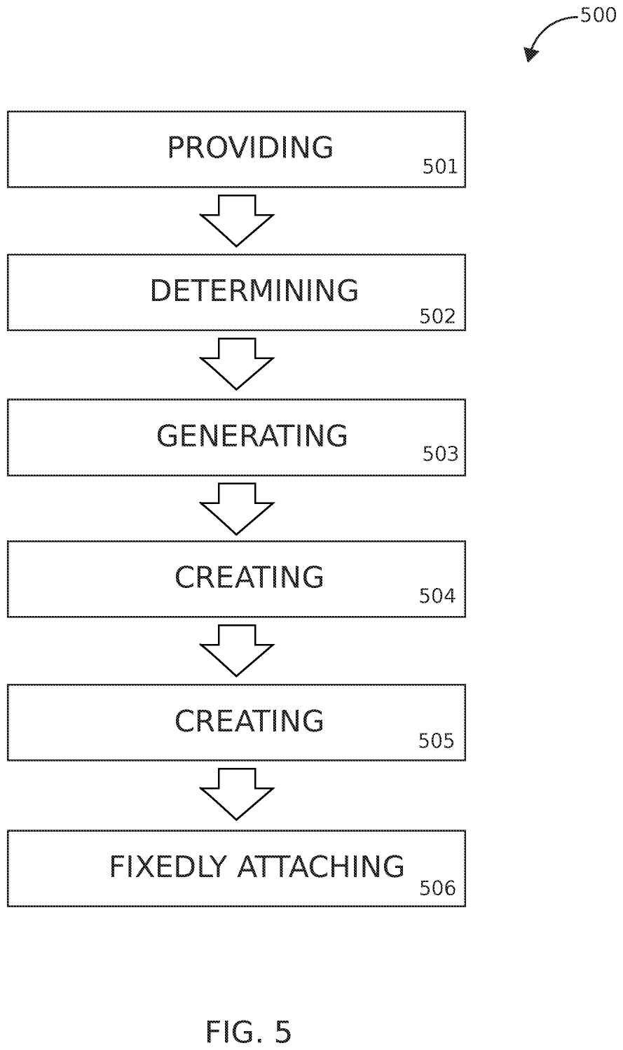

FIG. 5 is a flow diagram illustrating a method for creating a cover for a display screen, the cover 100 being for use by users with at least one eye having a refractive error, according to an embodiment of the present disclosure. In particular, the method for creating a cover for a display screen 500 may include one or more components or features of the cover 100 as described above. As illustrated, the method for creating a cover for a display screen 500 may include the steps of: step one 501, providing the cover as above; step two 502, determining the predetermined vision prescription of the user; step three 503, generating the optical power based on at least the predetermined vision prescription of the user; step four 504, creating the lens layer with the optical power; step five 505, creating the protective layer; and step six 506, fixedly attaching the rear protective surface of the protective layer to the front lens surface of the lens layer to create the cover, the cover having a size substantially equal to the display screen.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for creating a cover for a display screen are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A cover for a display screen, the cover being for use by users with at least one eye having a refractive error, the cover comprising:
a lens layer including a front lens surface and a rear lens surface configured for attachment to the display screen, the lens layer being made from a first transparent material, the lens layer structurally configured to focus light into the at least one eye of the user at an optical power corresponding to a predetermined vision prescription of the user so as to substantially correct the refractive error of the at least one eye of the user when the user is viewing the display screen through the cover; and
a protective layer including a front protective surface and a rear protective surface, the rear protective surface being fixedly attached to the front lens surface of the lens layer, the protective layer being made from a second transparent material so as to not impede a clarity of the lens layer.

2. The cover of claim 1, wherein the first transparent material and the second transparent material are made of a lightweight material capable of building an electrostatic charge so as to attach the rear lens surface to the display screen via static electricity.

3. The cover of claim 1, wherein the rear lens surface includes an adhesive thereon to adhesively attach the rear lens surface to the display screen.

4. The cover of claim 1, wherein the predetermined vision prescription of the user includes a measurement in diopters.

5. The cover of claim 1, wherein the predetermined vision prescription of the user includes one of a far point and near point of the user.

6. The cover of claim 4, wherein the optical power is generated based on the predetermined vision prescription of the user.

7. The cover of claim 1, wherein the optical power is generated based on the predetermined vision prescription of the user and a distance range between the at least one eye of the user and the display screen during use.

8. The cover of claim 6, wherein a curvature of the lens layer is determined by the predetermined vision prescription of the user.

9. The cover of claim 8, wherein the lens front surface has a first curvature and wherein the lens rear surface has a second curvature.

10. The cover of claim 9, wherein the first curvature and the second curvature are the same.

11. The cover of claim 9, wherein the first curvature and the second curvature are different.

12. The cover of claim 11, wherein a difference in curvature between the first curvature and the second curvature is determined by the predetermined vision prescription of the user.

13. The cover of claim 12, wherein the difference in curvature between the first curvature and the second curvature determines the optical power of the lens layer.

14. The cover of claim 13, wherein the user is farsighted, and wherein the first curvature and the second curvature are configured to converge light into the at least one eye of the user.

15. The cover of claim 13, wherein the user is nearsighted, and wherein the first curvature and the second curvature are configured to diverge light into the at least one eye of the user.

16. A cover for a display screen, the cover being for use by users with at least one eye having a refractive error, the cover comprising:
a lens layer including a front lens surface and a rear lens surface configured for attachment to the display screen, the lens layer being made from a first transparent material, the lens layer structurally configured to focus light into the at least one eye of the user at an optical power corresponding to a predetermined vision prescription of the user so as to substantially correct the refractive error of the at least one eye of the user when the user is viewing the display screen through the cover; and
a protective layer including a front protective surface and a rear protective surface, the rear protective surface being fixedly attached to the front lens surface of the lens layer, the protective layer being made from a second transparent material so as to not impede a clarity of the lens layer; and
wherein the first transparent material and the second transparent material are made of a lightweight material capable of building an electrostatic charge so as to attach the rear lens surface to the display screen via static electricity;
wherein a curvature of the lens layer is determined by the predetermined vision prescription of the user;
wherein the lens front surface has a first curvature and wherein the lens rear surface has a second curvature;
wherein a difference in curvature between the first curvature and the second curvature is determined by the predetermined vision prescription of the user;
wherein the user is farsighted, and wherein the first curvature and the second curvature are configured to converge light into the at least one eye of the user; and
wherein the user is nearsighted, and wherein the first curvature and the second curvature are configured to diverge light into the at least one eye of the user.

17. The cover of claim 16, further comprising set of instructions;
wherein the cover is arranged as a kit.

18. The cover of claim 17, wherein the kit includes at least two said covers having different optical powers.

19. A method of creating a cover for a display screen, the cover being for use by users with at least one eye having a refractive error, the method comprising:
providing the cover including:
a lens layer including a front lens surface and a rear lens surface configured for attachment to the display screen, the lens layer being made from a first transparent material, the lens layer structurally configured to focus light into the at least one eye of the user at an optical power corresponding to a predetermined vision prescription of the user so as to substantially correct the refractive error of the at least one eye of the user when the user is viewing the display screen through the cover; and
a protective layer including a front protective surface and a rear protective surface, the rear protective surface being fixedly attached to the front lens surface of the lens layer, the protective layer being made from a second transparent material so as to not impede a clarity of the lens layer;
determining the predetermined vision prescription of the user;
generating the optical power based on at least the predetermined vision prescription of the user;
creating the lens layer with the optical power;
creating the protective layer; and
fixedly attaching the rear protective surface of the protective layer to the front lens surface of the lens layer to create the cover, the cover having a size substantially equal to the display screen.

20. The method of claim 19, wherein the optical power is generated based on a comparison between the predetermined vision prescription of the user and a distance range between the at least one eye of the user and the display screen during use.
